(19) United States
(12) Patent Application Publication
(10) Pub. No.: US 2007/0138976 A1
(43) Pub. Date: Jun. 21, 2007

(54) Dielectric barrier discharge lamp drive circuit

(75) Inventor: Makoto Noda, Motosu-shi (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: LECIP CORPORATION, Motosu-shi, Gifu-ken (JP)

(21) Appl. No.: 10/596,999

(22) PCT Filed: Jan. 7, 2005
(86) PCT No.: PCT/JP05/00128

§ 371 Date: Jul. 5, 2006

(30) Foreign Application Priority Data
Jan. 9, 2004 (JP) 2004-004398

(51) Int. Cl. H05B 37/02

(52) U.S. Cl. 315/291; 315/307

(57) ABSTRACT

A dielectric barrier discharge lamp drive circuit having a thickness so that sufficient mechanical strength of a glass plate is obtained and a relatively large illumination area. The drive circuit is driven at low voltage and reduces apparent current. The drive circuit applies a high frequency power to a flat panel discharge lamp (19) with a reactor (32). In a lighted state, a state close to a series resonance of the inductance of the reactor and an electrostatic capacity of the glass plate (11, 12) is set. The inductance value of the reactor is selected so that the frequency of the high frequency power is slightly smaller than the series resonance frequency, and the impedance of the load as viewed from an AC source (31) is set to the rated impedance. A high light emitting efficiency is obtained in such a configuration when Xe (xenon) gas that does not cause environmental problems is used as the discharge gas.

### TECHNICAL FIELD

The present invention relates to a discharge lamp, and more specifically, to a drive circuit for lighting a so-called dielectric barrier discharge lamp provided with a current limiting function for preventing impedance of the discharge lamp itself from causing overcurrent when emitting light through discharge.

### BACKGROUND ART

Known dielectric barrier discharge lamps have a planar or cylindrical shape. As shown in FIG. 8, a flat panel discharge lamp (refer to, for example, patent publication 1) has dielectric plates 11 and 12, which resemble glass plates and which are arranged facing each other. The space between the edges of the opposing surfaces of the dielectric plates 11 and 12 are sealed by a sealing member (e.g., seal glass) 13 so as to form a dielectric sealed container. Discharge gas 16 is contained in the dielectric sealed container, and electrodes 14 and 15 are attached facing each other with the dielectric plates 11 and 12 and the discharge gas 16 located in between thereby forming a discharge space. Fluorescent layers 17 and 18 are formed on the opposing inner surfaces of the dielectric plates 11 and 12 when necessary. As the discharge gas 16, Xe (xenon) gas is used. Alternatively, mercury vapor and Ar (argon) or Ne (neon) gas etc. is used.

In a light emission drive circuit for the flat panel discharge lamp 19, AC power from, for example, a commercial power supply 21 is rectified and smoothed by a rectification smoothing circuit 22 so as to form a DC power supply 23. The DC power from the DC power supply 23 is converted to high frequency power by an inverter 24. The high frequency power is boosted by a transformer 25 and applied between the electrodes 14 and 15 so that discharge occurs between the dielectric plates 11 and 12 (referred to as dielectric barrier discharge since the discharge occurs with the dielectric plates 11 and 12). This generates discharge plasma formed by ionization of the discharge gas 16 and externally irradiates ultraviolet rays. Alternatively, the fluorescent layers 17 and 18 are excited by the ultraviolet rays and natural light is externally irradiated. That is, light emission occurs to light the discharge lamp 19. The dielectric plate 12 on the side opposite the illumination surface may be a metal plate and may be used to also function as the electrode 15. The electrode 14 on the illumination surface side may be a transparent electrode when necessary, and the fluorescent layer 17 may be omitted.

Since AC power is applied to the discharge lamp 19 through the two dielectric plates 11 and 12, that is, through a thick barrier even after being lighted, the high frequency voltage applied between the electrodes 14 and 15 must be extremely high. In addition, since the impedance between the electrodes 14 and 15 is mainly based on the electrostatic capacity of the dielectric plates 11 and 12, the phase of the current that flows during the application of voltage advances greatly and lowers the power factor. Therefore, the power capacity (VA) of a circuit such as the step-up transformer 25 and the inverter 24 becomes extremely large compared to the actual capacity (W) applied to the discharge lamp 19, that is, the power loss becomes large. Thus, equipment used as the flat panel discharge lamp lighting device becomes extremely large and it becomes difficult to make the equipment thinner or lighter.

To solve this problem, the thickness of the barrier may be reduced, that is, the thickness of the dielectric plates 11 and 12 may be reduced. Since the mechanical strength would become insufficient, ribs may be arranged at appropriate intervals between the dielectric plates 11 and 12. However, when used in the field of illumination in which a relatively large area is required, the arrangement of a plurality of ribs as reinforcement members will affect the uniformity of light emission in an undesirable manner. Further, the manufacturing steps would increase thereby raising costs.

An example of a dielectric barrier discharge lamp having a cylindrical shape is shown in FIG. 9. Dielectric tubes 51 and 52, which may be coaxial glass tubes, respectively have one end closed by plates 51a and 52a and another end sealed by a sealing member (e.g., seal glass) 53. The dielectric tubes are fixed to each other to form a dielectric sealed container. Discharge gas 54, such as xenon gas, mercury vapor and neon, or argon gas, is contained in the dielectric sealed container. Electrodes 55 and 56 are formed facing each other entirely on the outer surface of the dielectric tube 51 and the inner surface of the dielectric tube 52 with the dielectric tubes 51, 52 and the discharge gas 54 located in between so as to define a discharge space. A fluorescent layer 57 is formed entirely on the inner surface of one of the dielectric tubes 61 when necessary.

An example in which the tube has a cylindrical shape is shown in FIG. 10. The dielectric sealed container is formed by a dielectric tube 61 such as a glass tube having two closed ends, with discharge gas 62 contained in the sealed container. Electrodes 63 and 64 are formed facing each other on the outer surface of the dielectric tube 61 spaced by distance D1 with the dielectric tube 61 and the discharge gas 62 located in between to form a discharge space. The fluorescent layer 65 is formed on the inner surface of the dielectric tube 61 when necessary.

An inductance element is connected in series to a normal fluorescent lamp to prevent overcurrent after the fluorescent lamp is lighted. However, in the above dielectric barrier discharge lamps in which the electrodes are formed facing each other with a dielectric body and discharge gas located in between to form the dielectric sealed container, the dielectric body of the sealed container acts as a relatively high impedance with respect to the high frequency current after lighting. Since the discharge lamp itself has a current limiting function to prevent overcurrent from flowing after lighting, this is advantageous in that a current limiting inductance element does not need to be added, as apparent from the description of, for example, patent publication 2.
[Patent Publication 1] Japanese Laid-Open Patent Publication No. 2003-31182 (FIG. 2)
[Patent Publication 2] Japanese Laid-Open Patent Publication No. 11-307051 (paragraph number [0019])

### DISCLOSURE OF THE INVENTION

It is an object of the present invention to provide a dielectric barrier discharge lamp drive circuit driven by relatively low voltage and having a small power loss with a simple configuration, that is, without using reinforcement members in the dielectric sealed container even when the dielectric barrier discharge lamp has a relatively large area and includes a dielectric container having a thickness for sufficient strength.

One aspect of the present invention is a dielectric barrier discharge lamp drive circuit including a sealed container having a dielectric body and containing discharge gas, and a pair of electrodes, facing each other on the sealed container with the dielectric body and the discharge gas located therebetween. The drive circuit includes a drive AC generation circuit for generating high frequency power applied between the pair of electrodes, and a reactor member connected in series between the drive AC generation circuit and the discharge lamp.

In the present invention, the impedance of the dielectric barrier discharge lamp when viewed from the drive circuit corresponds to a reduced impedance of a dielectric electrostatic capacitor forming discharge space with the impedance of a reactor component member. The reduced impedance enables the drive voltage to be decreased. Thus, a dielectric body having a thickness for solely obtaining sufficient mechanical strength may be used. Further, the power factor is improved and loss is reduced. Additionally, there is no need for the structure of the discharge lamp to be complicated, and the size and weight may be reduced with a light emission surface having a relatively large area. The dielectric body forming the discharge space may be planar and formed by two flat plates or may be cylindrical and formed by two curved plates.

### BRIEF DESCRIPTION OF THE DRAWINGS

FIG. 1 is a diagram showing a basic configuration example of a drive circuit according to the present invention;

FIG. 2A is a diagram showing an equivalent circuit of the drive circuit of FIG. 1 before lighting;

FIG. 2B is a diagram showing an equivalent circuit of a stable lighting state of the drive circuit of FIG. 1;

FIG. 2C is a diagram showing a simplified equivalent circuit of the drive circuit of FIG. 1;

FIG. 3 is a diagram showing an example of an impedance frequency characteristic when viewing the discharge lamp from the drive circuit;

FIG. 4 is a circuit diagram showing a drive circuit according to a first embodiment of the present invention;

FIG. 5 is a circuit diagram showing a drive circuit according to a second embodiment of the present invention;

FIG. 6A is diagram showing an equivalent circuit of the drive circuit of FIG. 5;

FIG. 6B is a diagram showing a circuit example for measuring equivalent leakage reluctance of the drive circuit of FIG. 5;

FIG. 7A is a diagram showing an example of a leakage transformer 37 of the drive circuit of FIG. 5;

FIG. 7B is a diagram showing another example of the leakage transformer 37 of the drive circuit of FIG. 5;

FIG. 8 is a diagram showing a conventional flat panel discharge lamp drive circuit;

FIG. 9A is a cross-sectional diagram of a conventional cylindrical discharge lamp taken along line 9A-9A in FIG. 9B;

FIG. 9B is a cross-sectional diagram taken along line 9B-9B in FIG. 9A showing the cylindrical discharge lamp;

FIG. 10A is a cross-sectional taken along line 10A-10A of FIG. 10B showing another conventional cylindrical discharge lamp; and

FIG. 10B is a cross-sectional diagram taken along line 10B-10B in FIG. 10A showing the cylindrical discharge lamp.

### BEST MODE FOR CARRYING OUT THE INVENTION

[Basic Configuration]

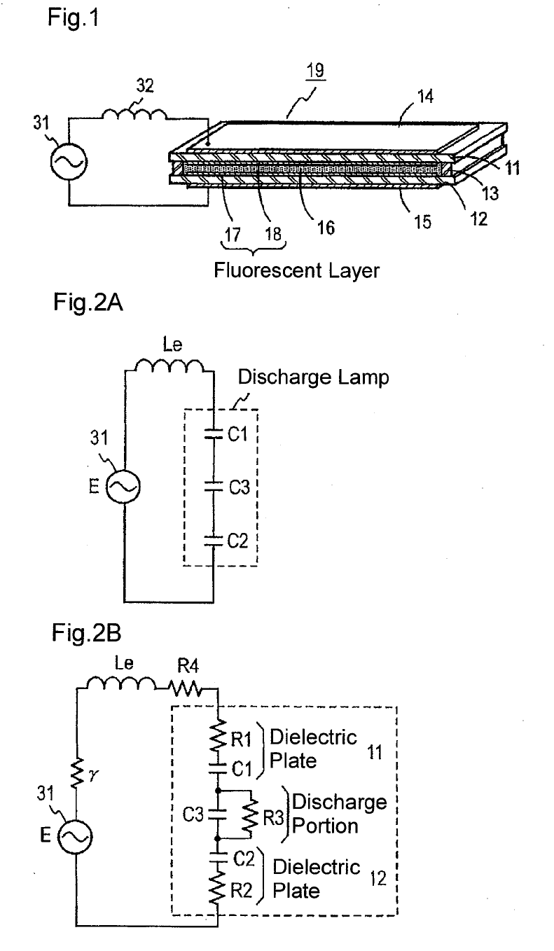

The basic configuration of a dielectric barrier discharge lamp drive circuit according to the present invention will now be described with reference to FIG. 1 using a flat panel discharge lamp as an example. In the present invention, high frequency power of, for example, about 10 kHz to 100 kHz from a drive AC generation circuit 31 is applied to a flat panel discharge lamp 19 via a reactor member 32. Parts of a discharge lamp 19 corresponding to those shown in FIG. 8 are denoted with the same reference number. The advantages of the reactor member 32 and the preferred inductance value will now be described.

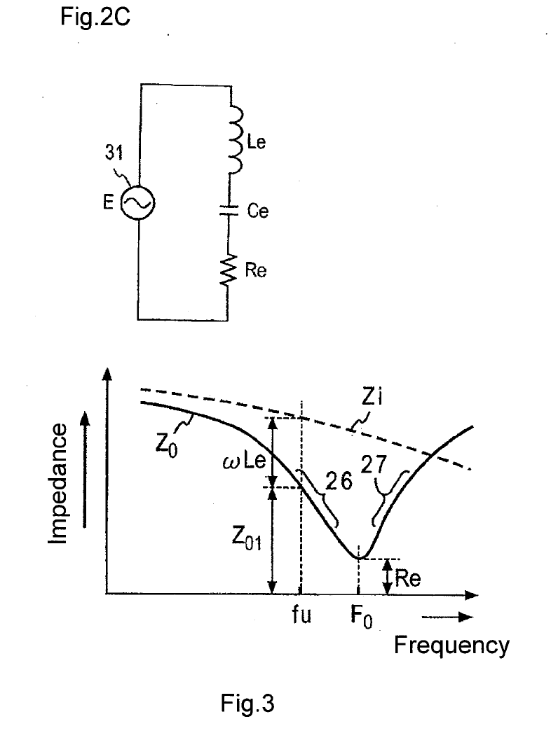

An equivalent circuit including the flat panel discharge lamp 19 is shown in FIG. 2. FIG. 2A shows a state before the discharge lamp 19 is lighted. In this state, high frequency power of voltage E from drive AC generation circuit 31 is applied to a series-connected circuit including inductance Le (correctly, the inductance value representing the inductance element of Le, same expressions are used hereinafter) of the reactor member 32, electrostatic capacitors C1 and C2 corresponding to each plate thickness of dielectric plates 11 and 12, and an electrostatic capacitor C3 of the discharge space between the dielectric plates 11 and 12.

When the discharge lamp 19 is lighted, as shown in FIG. 2B, resistors R1 and R2 are respectively inserted to be connected in series to the capacitors C1 and C2 of the dielectric plates 11 and 12, a resistor R3 is connected in parallel to the capacitor C3 of the discharge space, a resistor R4 is connected in series to the inductance Le of the reactor member 32, and an internal resistor r of the drive AC generation circuit 31 is connected in series to the inductance Le. The resistor R3 of the discharge space is a resistor for the discharge current and is significantly small. Therefore, the capacitor C3 of the discharge space is in a substantially short circuited state by the resistor R3.

The equivalent circuit of FIG. 2B may be simplified by grouping the same components as shown in FIG. 2C. That is, the AC power E is applied to the series-connected circuit of the inductance Le, the capacitor Ce and the resistor Re. The capacitor Ce is a series-connected capacitor mainly including the capacitors C1 and C2, and the resistor Re is a series-connected resistor including the resistors R1, R2, R3, and r.

As can be understood from the equivalent circuit shown in FIG. 2C, the dielectric impedance of the reactor member 32 cancels at least part of the capacitive impedance of the dielectric plates 11 and 12. This lowers the application voltage in the lighted state and improves the power factor. The inductance Le of the reactor member 32 is selected so as to be greater than the impedance of when the equivalent circuit shown in FIG. 2C is resonated but less than the impedance of when the reactor member 32 is not employed. That is, the synthetic impedance Z₀ of the discharge lamp 19 when viewed from the drive AC generation circuit 31 is expressed by the following equation.
Z₀=Re+j[ωLe−1/(ωCe)] (1)

The frequency characteristic of the synthetic impedance Z₀ is shown by the solid line in FIG. 3. The frequency characteristic of the impedance Zi of when the reactor member 32 is not employed is shown by the broken line in FIG. 3. As apparent from FIG. 3, Z₀ is slightly smaller than Zi when the frequency f(ω/2π) of the high frequency power is low, decreases in a relatively sudden manner as the frequency approaches the resonance frequency F₀(2πF₀=ω₀, ω₀=√(1/(LeCe))), and increases in a relatively sudden manner when becoming higher than F₀. In comparison, Zi gradually becomes smaller as the frequency becomes higher. At the resonance frequency F₀, the impedance Z₀ becomes significantly small as shown by Re and causes the flow of overcurrent. Therefore, at the frequency fu of the high frequency power generated by the drive AC generation circuit 13, the inductance Le is selected so that Z₀ is less than Zi and so that Z₀ is not in a resonance state. It is considered that a current limiting impedance element does not have to be inserted since the dielectric barrier discharge lamp itself has a current limiting function. However, since the impedance Zi of the discharge lamp itself is too large in the dielectric barrier discharge lamp, the impedance Zi of the dielectric barrier discharge lamp itself is lowered using the reactor member 32 in the present invention so that the synthetic impedance Z₀ with the impedance Zi of the dielectric barrier discharge lamp itself is set to the intended current limiting value. This technique basically differs from a technique for inserting an impedance element having a current limiting function to increase the impedance of the fluorescent lamp itself during a discharging state in the conventional fluorescent lamp.

In the discharge barrier discharge lamp, discharge does not simultaneously start between each part (point) of the opposing electrodes, which have a large area, but starts at one certain part somewhere and then spreads out so that the entire surface enters a discharging state. From this aspect as well, the impedance Z₀ of a certain extent is required in the discharging state. The required impedance becomes greater as the area of the electrodes 14 and 15 becomes larger and becomes greater as the pressure of the discharge gas of the discharge lamp 19 becomes higher. Therefore, the inductance Le is selected so that the synthetic impedance Z₀ is set to the current limiting impedance necessary for uniform light emission of the discharge lamp 19.

Further, it is desirable that the discharge gas does not contain mercury in terms of environmental aspects. In this regard, Xe (xenon) gas is currently considered to be effective as the non-mercury discharge gas. The Xe gas has lower light emitting efficiency as the frequency increases. Therefore, as shown in FIG. 3, the inductance Le is preferably selected so that the used high frequency power frequency fu is lower than the resonance frequency F₀ of the synthetic impedance Z₀ and so that the impedance Z₀₁ obtained by decreasing the impedance 2πfuLe of the inductance Le at the frequency fu from the impedance Zi at the frequency fu is set to the current limiting impedance Z₀₁ necessary in the discharging state. If the light emitting efficiency is not much affected, the inductance Le may be selected so that the current limiting impedance Z₀₁ is set at a state in which the frequency fu is higher than the resonance frequency F₀. That is, Le may be selected so that the used frequency fu is positioned at the steep gradient parts 26 and 27 in the resonance frequency curve.

### First Embodiment

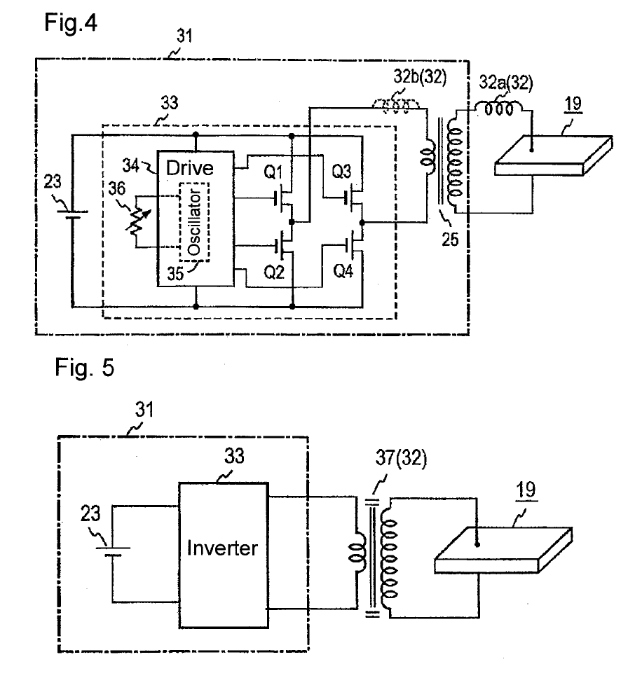

A dielectric barrier discharge lamp drive circuit according to a first embodiment of the present invention will now be described with reference to FIG. 4. The DC power from a DC power supply 23 is converted to high frequency power by an inverter 33 in a drive AC generation circuit 31. The high frequency power is boosted from about 12 V to about 1 kV to 2 kV by a step-up transformer 25. The boosted high frequency power is then applied to the flat panel discharge lamp 19 via an inductance element 32a, which functions as the reactor member 32. The DC power supply 23 may be configured, for example, so that the DC power is generated by rectifying commercial AC power, as shown in FIG. 8.

The inverter 33 may have a configuration similar to that of the prior art. As shown in FIG. 4, a series-connected circuit of switching elements Q1 and Q2 and a series-connected circuit of switching elements Q3 and Q4 are connected to the DC power supply 23. A primary coil of the transformer 25 is connected to a connecting point of the switching elements Q1 and Q2 and the connecting point of the switching elements Q3 and Q4. A drive circuit 34 is connected to a DC power supply 23. The drive circuit 34 distributes an oscillation signal of an oscillator 35 arranged therein, drives the switching elements Q1 to Q4, simultaneously activates the switching elements Q1 and Q4, inactivates the switching elements Q2 and Q3, and alternately performs activation of the switching elements Q2 and Q3 and inactivation of the switching elements Q1 and Q4. By driving the switching elements in the above manner, the high frequency AC power generated by the primary coil of the transformer 25 is boosted by the transformer 25.

The inductance value Le of the inductance element 32a functioning as the reactor member 32 is selected so that the value set as the intended current limiting impedance Z₀₁ is obtained by measuring the impedance Zi in the lighted state of the flat panel discharge lamp 19 when the inductance element 32a is not connected and subtracting the impedance jωLe from the impedance Zi. That is, Le satisfying the following equation is used.
Le=(Zi−Z₀₁)/(2πfu) (2)

Alternatively, since the electrostatic capacities C1 and C2 of the used dielectric plates 11 and 12 and the equivalent resistance Re in FIG. 2C are obtained through calculation, equation (2) may all be obtained through calculation. The selection of Le does not need to be that accurately determined as apparent from the above description, and Le may be selected so that the used frequency fu is around or relatively close to the resonance frequency F₀.

Instead of arranging the inductance element 32a on the secondary side of the transformer 25, the inductance element 32b may be connected in series to the primary coil of the transformer 25 as shown by the broken lines in FIG. 4. This would enable the withstanding voltage of the inductance element 32b and the withstanding voltage of the inductance element 32b and the housing of the drive AC generation circuit 31 to be set lower than when the inductance element is arranged on the secondary side of the transformer 25. Further, insulation is facilitated.

The advantages of the present invention as described above are obtained by using the inductance elements 32a and 32b. Further, since an operation state close to series-connected resonance is obtained by inserting the inductance element 32a or 32b even if the output signal of the inverter 33 is a square wave, the voltage waveform to be applied to the flat panel discharge lamp 19 becomes closer to a sine wave. This is advantageous in that a high frequency noise is not externally generated.

A proper state may not necessary be realized even if the inductance value Le is set as described above. Thus, it is preferable that, for example, a variable resistor 36 be connected to the oscillator 35 as part of an oscillation frequency determining element of the oscillator 35 in the inverter 33, as shown in FIG. 4, to adjust the oscillation frequency of the oscillator 35, that is, the used frequency fu, and to set the current limiting current in the lighted state to the intended value. Deviations in the resonance point F₀ due to the type of flat panel discharge lamp 19 of manufacturing variations of the lamp is easily absorbed by finely adjusting the frequency fu of high frequency power.

### Second Embodiment

A dielectric barrier discharge lamp drive circuit according to a second embodiment of the present invention will now be described with reference to FIG. 5. In the second embodiment, the high frequency AC power from the AC power generation circuit 31 is applied to the flat panel discharge lamp 19 via a leakage transformer 37, which functions as the reactor member 32. In the example shown in FIG. 5, the leakage transformer 37 is connected to the output of the inverter 33 in place of the transformer 25 of FIG. 4, and a flat panel discharge lamp 19 is directly connected to the leakage transformer 37. For example, a neon transformer used to light the neon lamp is used to prevent overcurrent in a lighted state. However, the leakage transformer is not used as the transformer 25 as shown in FIG. 8 since the dielectric barrier discharge lamp itself has the current limiting function, as described above. The second embodiment is configured so that the reactance component of the leakage transformer 37 cancels the electrostatic capacitor component in the lighted state of the flat panel discharge lamp 19, that is, so that the resonating state is approached by the two components.

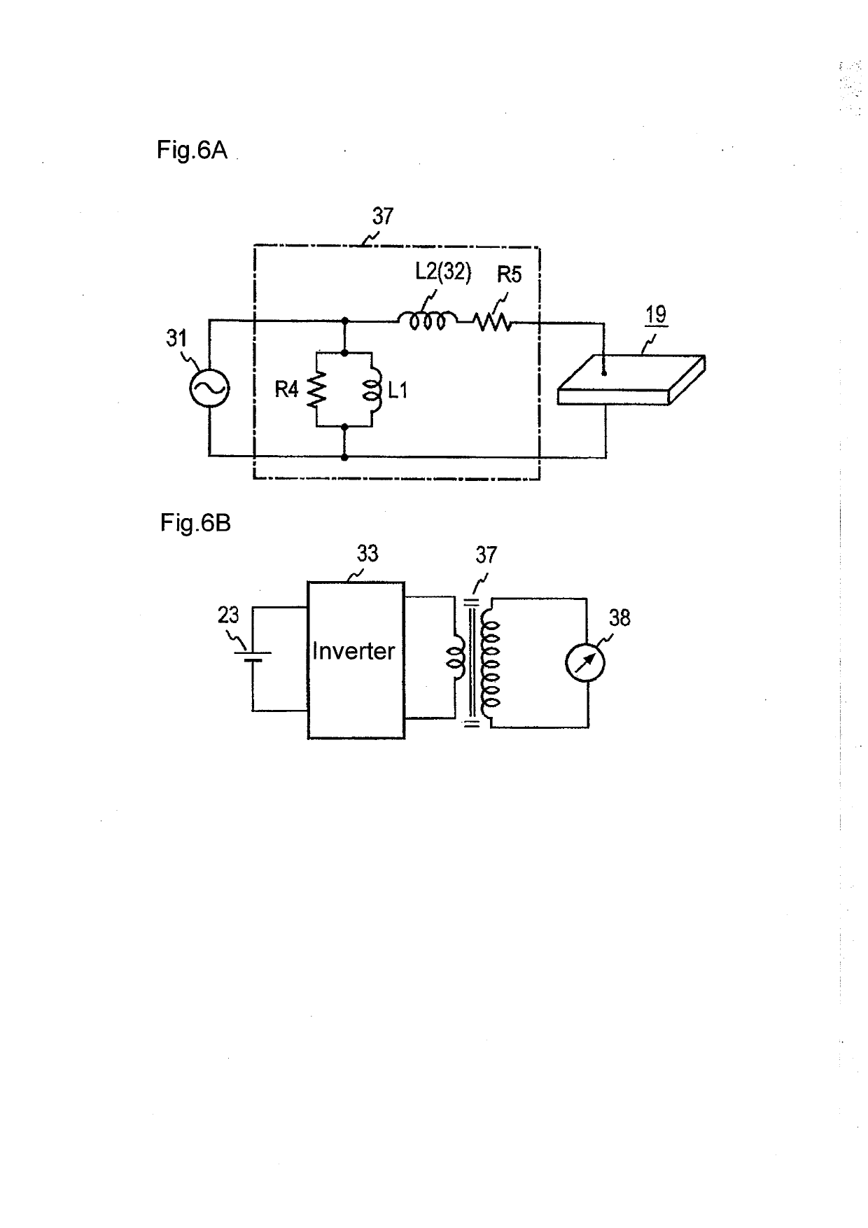

It is apparent that the equivalent circuit for the second embodiment has the configuration shown in FIG. 6A from the known equivalent circuit of a normal transformer or leakage transformer. That is, a parallel-connected circuit of the inductance L1 and the resistor R4 is connected to the drive AC generation circuit 31, and the flat panel discharge lamp 19 is connected via the series-connected circuit of the inductance L2 and the resistor R5. More accurately, the equivalent inductance L2 functions as the reactance of the reactor member 32.

Accordingly, in the second embodiment, the inductance L2 is selected so as to have a value similar to the inductance value of the inductance element 32a or 32b mentioned above. The secondary side of the leakage transformer 37 is short circuited as shown in FIG. 6B, and the short circuit current I is measured by an ammeter 38. The short circuit current I has a relationship in which the applied high frequency voltage E, L2 and the applied high frequency voltage frequency fu satisfies I=E/(j2πfuL2). The voltage E is gradually increased from a small value, and the voltage E is set so that the current I becomes a rated current in a lighted state of the flat panel discharge lamp 19. Here, L2 is obtained from E, I, and fu. Since L2 is proportional to the leakage amount of the magnetic flux, the leakage amount may be adjusted to set L2, that is, the reluctance Le to the above value.

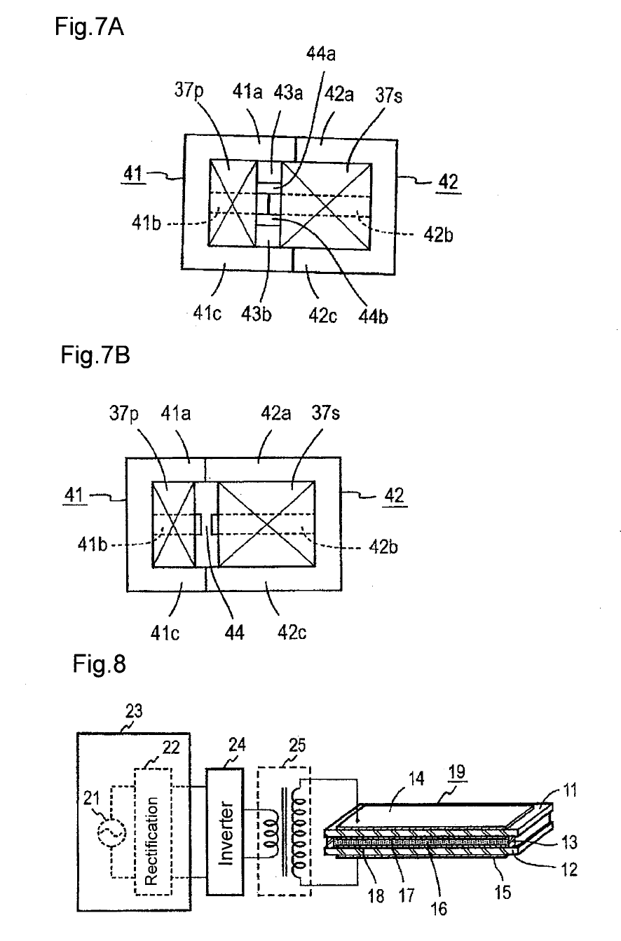

An example of the leakage transformer 37 is shown in FIG. 7. In FIG. 7A, end faces of leg portions 41a, 41b, 41c and 42a, 42b, 42c in two E-shaped magnetic cores 41 and 42 are abutted against each other, and primary coil 37p and secondary coil 37s are each wound around each of the middle leg portions 41b and 42b. Leakage magnetic portions 43a and 43b of a magnetic material projecting towards the middle leg portions 41b, 42b are each coupled to the two leg portions 41a and 41c located at the outer sides between the primary coil 37p and the secondary coil 37s. The amount of leakage magnetic flux, that is, the leakage inductance L2 is determined by the distance or the opposing area of the magnetic gap 44a and 44b between the leakage magnetic portion 43a and 43b and the leg portion 41b and 42b. As shown in FIG. 7B, the leakage magnetic portions 43a and 43b may be omitted, and the magnetic gap 44 may be formed between the leg portions 41b and 42b in the E-shaped magnetic cores 41 and 42 without the leg portions 41b and 42b contacting each other. The leakage transformer 37 may have any configuration and be a pot shaped magnetic core or an inner core type, and in particular, may be a transformer that produces leakage magnetic flux without forming a magnetic gap since the frequency fu of the high frequency power is high.

In the second embodiment, the leakage transformer 37 functions as the step-up transformer 25 and the reactor member 32. Thus, the number of components is small and costs are low. In the second embodiment, a configuration in which the frequency of the high frequency power is adjustable is also used so that the current limiting impedance Z₀ is set to an appropriate value.

In the above description, the inverter 33 is not limited to a bridge type and may have other configurations such as a center tap type, an amplifier type, or the like.

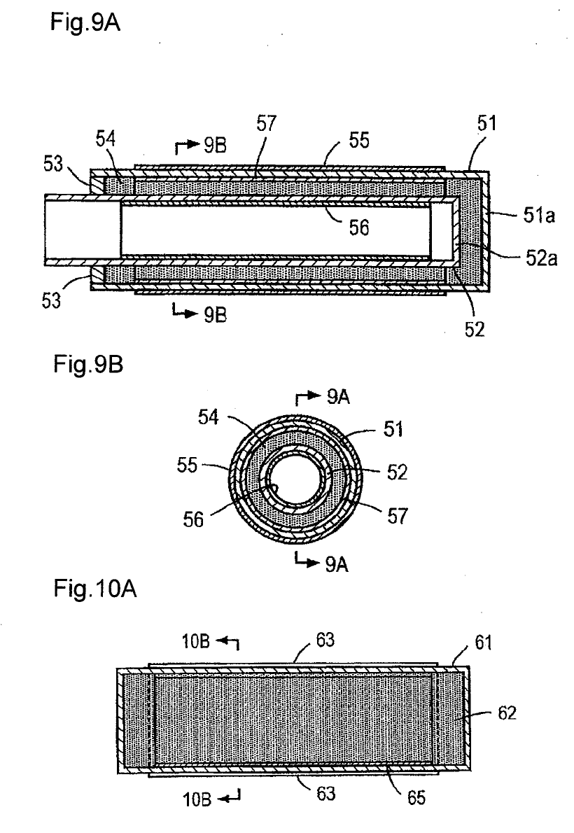

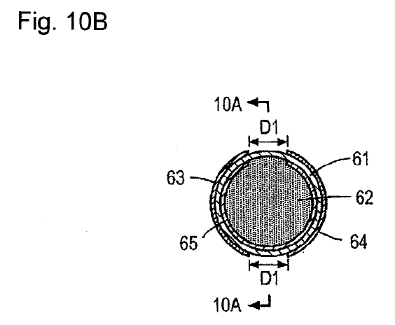

The present invention is not only applicable to the flat panel discharge lamp but is also applicable to the cylindrical discharge lamp shown in FIG. 9 and FIG. 10.

1. A dielectric barrier discharge lamp drive circuit comprising a sealed container having a dielectric body and containing discharge gas, and a pair of electrodes, facing each other on the sealed container with the dielectric body and the discharge gas located therebetween;
a drive AC generation circuit for generating high frequency power applied between the pair of electrodes; and
a reactor member connected in series between the drive AC generation circuit and the discharge lamp.

2. The dielectric barrier discharge lamp drive circuit according to claim 1, wherein the reactor member is an inductance element.

3. The dielectric barrier discharge lamp drive circuit according to claim 1, wherein the reactor member is a leakage transformer.

4. The dielectric barrier discharge lamp drive circuit according to claim 1, wherein the drive AC generation circuit includes an inverter for converting DC power to the high frequency power, the inverter including a means for adjusting the frequency of the high frequency power.

5. The dielectric barrier discharge lamp drive circuit according to claim 1, wherein the reactor member has an inductance value selected so that an impedance of a load as viewed from the drive AC generation circuit is set to a current limiting impedance necessary for uniform light emission of the discharge lamp.

6. The dielectric barrier discharge lamp drive circuit according to claim 1, wherein a series resonance state is set by an inductance component of the reactor member and a load electrostatic capacity component of the discharge lamp, and the inductance component has an inductance value selected so that the frequency of the high frequency power is lower than the resonance frequency.

7. The dielectric barrier discharge lamp drive circuit according to claim 1, wherein a series resonance state is set by an inductance component of the reactor member and a load electrostatic capacity component of the discharge lamp, and the inductance component has an inductance value selected so that the frequency of the high frequency power is positioned at a steep gradient part in a resonance impedance frequency characteristic curve.

8. The dielectric barrier discharge lamp drive circuit according to claim 1, wherein the impedance component has an inductance value selected so that impedance of the reactor member cancels at least part of the impedance of the discharge lamp.

9. The dielectric barrier discharge lamp drive circuit according to claim 8, wherein a series resonance state is set by an inductance component of the reactor member and a load electrostatic capacity component of the discharge lamp, and the inductance component has an inductance value selected so that the frequency of the high frequency power of the drive AC generation circuit is set in the vicinity of the resonance frequency.

10. The dielectric barrier discharge lamp drive circuit according to claim 8, wherein a series resonance state is set by an inductance component of the reactor member and a load electrostatic capacity component of the discharge lamp, and the inductance component has an inductance value selected so that the frequency of the high frequency power of the drive AC generation circuit is lower than the resonance frequency.

11. The dielectric barrier discharge lamp drive circuit according to claim 1, wherein the drive AC generation circuit includes a step-up transformer for boosting the high frequency power, and the reactor member is connected in series between the step-up transformer and the discharge lamp.

12. The dielectric barrier discharge lamp drive circuit according to claim 1, wherein the drive AC generation circuit includes a step-up transformer, having a primary coil and a secondary coil, for boosting the high frequency power, and the reactor member is connected in series to the primary coil of the step-up transformer.

13. The dielectric barrier discharge lamp drive circuit according to claim 2, wherein the drive AC generation circuit includes an inverter for converting DC power to the high frequency power, the inverter including a means for adjusting the frequency of the high frequency power.

14. The dielectric barrier discharge lamp drive circuit according to claim 2, wherein the reactor member has an inductance value selected so that an impedance of a load as viewed from the drive AC generation circuit is set to a current limiting impedance necessary for uniform light emission of the discharge lamp.

15. The dielectric barrier discharge lamp drive circuit according to claim 2, wherein a series resonance state is set by an inductance component of the reactor member and a load electrostatic capacity component of the discharge lamp, and the inductance component has an inductance value selected so that the frequency of the high frequency power is lower than the resonance frequency.

16. The dielectric barrier discharge lamp drive circuit according to claim 1, wherein a series resonance state is set by an inductance component of the reactor member and a load electrostatic capacity component of the discharge lamp, and the inductance component has an inductance value selected so that the frequency of the high frequency power is positioned at a steep gradient part in a resonance impedance frequency characteristic curve.

18. The dielectric barrier discharge lamp drive circuit according to claim 2, wherein the impedance component has an inductance value selected so that impedance of the reactor member cancels at least part of the impedance of the discharge lamp.

19. The dielectric barrier discharge lamp drive circuit according to claim 18, wherein a series resonance state is set by an inductance component of the reactor member and a load electrostatic capacity component of the discharge lamp, and the inductance component has an inductance value selected so that the frequency of the high frequency power of the drive AC generation circuit is set in the vicinity of the resonance frequency.

20. The dielectric barrier discharge lamp drive circuit according to claim 18, wherein a series resonance state is set by an inductance component of the reactor member and a load electrostatic capacity component of the discharge lamp, and the inductance component has an inductance value selected so that the frequency of the high frequency power of the drive AC generation circuit is lower than the resonance frequency.
